(19) United States
(12) Patent Application Publication
(10) Pub. No.: US 2016/0348622 A1
(43) Pub. Date: Dec. 1, 2016

(54) PIPING CONNECTION STRUCTURE

(71) Applicant: HONDA MOTOR CO., LTD., Tokyo (JP)

(72) Inventors: Kazuhito HOTTA, Iruma-gun (JP); Takahiro SANO, Asaka-shi (JP); Yasuhiro MATSUI, Iruma-gun (JP)

(21) Appl. No.: 15/131,098

(22) Filed: Apr. 18, 2016

(30) Foreign Application Priority Data
May 29, 2015 (JP) 2015-110664

(51) Int. Cl. F02M 37/00

(52) U.S. Cl. CPC F02M 37/0017

(57) ABSTRACT

In a piping connection structure of a vehicle including: a throttle body connected to a power unit of the vehicle to adjust an intake air amount; a fuel injection device for injecting fuel to an intake passage including the throttle body; first pipings attached to the fuel injection device; and second pipings provided separately from the first pipings, and having end parts connected to the first pipings so as to intersect with the first pipings, a connection part between the first pipings and the second pipings has a long adjustment holes, which extend so as to allow adjustment of relative angles between the first pipings and the second pipings.

### CROSS-REFERENCE TO RELATED APPLICATION

Priority is claimed on Japanese Patent Application No. 2015-110664, filed on May 29, 2015, the contents of which are incorporated herein by reference.

### BACKGROUND OF THE INVENTION

Field of the Invention

The present invention relates to a piping connection structure.

Description of Related Art

Conventionally, there has been a piping connection structure disclosed in Japanese Patent Application Publication No. 2002-339836, for example. Here, a fuel rail attached to multiple fuel injection valves of an engine, and a fuel conduit provided separately from the fuel rail, and having an end part connected to the fuel rail so as to intersect with the fuel rail are joined with a collar, and then the collar is fastened and fixed with a bolt.

### SUMMARY OF THE INVENTION

However, if the height of the fuel injection valve is set for each model, the length of the fuel conduit needs to be set for each model. For this reason, there has been a need to improve versatility of the fuel conduit.

Hence, the present invention aims to improve versatility of piping, in a piping connection structure of a vehicle including: first piping attached to a fuel injection device; and second piping provided separately from the first piping, and having an end part connected to the first piping so as to intersect with the first piping.

As means for solving the above problem, an invention described in claim 1 is a piping connection structure of a vehicle (1) including: a throttle body (30) connected to a power unit (10) of the vehicle (1) to adjust an intake air amount; a fuel injection device (50) for injecting fuel to an intake passage including the throttle body (30); first piping (61, 63) attached to the fuel injection device (50); and second piping (62, 64) provided separately from the first piping (61, 63), and having an end part connected to the first piping (61, 63) so as to intersect with the first piping (61, 63), characterized in that a connection part (70) between the first piping (61, 63) and the second piping (62, 64) has a long adjustment hole (70h), which extends so as to allow adjustment of a relative angle between the first piping (61, 63) and the second piping (62, 64).

An invention described in claim 2 is characterized in that: the connection part (70) includes a flow path forming portion (73) forming a flow path that guides fuel from the second piping (62, 64) to the first piping (61, 63), a first connection part (74) provided on one side of the flow path forming portion (73), and a second connection part (75) provided on the other side of the flow path forming portion (73) opposite to the first connection part (74); and the adjustment hole (70h) includes a first adjustment hole (74h) formed in the first connection part (74), and a second adjustment hole (75h) formed in the second connection part (75).

An invention described in claim 3 is characterized in that: the fuel injection device (50) includes a first injector (51, 53) and a second injector (52, 54); the first injector (51, 53) and the second injector (52, 54) are arranged side by side in the vehicle width direction; the first piping (61, 63) extends in the vehicle width direction, so as to straddle the first injector (51, 53) and the second injector (52, 54); and the adjustment hole (70h) is formed into an arc shape, along the outer periphery of the first piping (61, 63) in side view.

An invention described in claim 4 is characterized in that: a supporting member (77, 78) supporting the first piping (61, 63) is provided in the throttle body (30); and a spacer (79) is provided between the first piping (61, 63) and the supporting member (77, 78).

An invention described in claim 5 is characterized in that: the first piping (61, 63) includes upstream first piping (61a, 63a) connected to the upstream side of the second piping (62, 64), and downstream first piping (61b, 63b) connected to the downstream side of the second piping (62, 64); the connection part (70) includes an upstream connection part (71a, 72a) connecting the upstream first piping (61a, 63a) and the upstream side of the second piping (62, 64), and a downstream connection part (71b, 72b) connecting the downstream first piping (61b, 63b) and the downstream side of the second piping (62, 64); and

the adjustment hole (70h) is formed in both of the upstream connection part (71a, 72a) and the downstream connection part (71b, 72b).

An invention described in claim 6 is characterized in that: the fuel injection device (50) includes a first injector (51, 53) and a second injector (52, 54); the first injector (51, 53) and the second injector (52, 54) each includes an upstream injector (51a, 52a, 53a, 54a) and a downstream injector (51b, 52b, 53b, 54b); the upstream injector (51a, 52a, 53a, 54a) is provided in the upstream first piping (61a, 63a); and the downstream injector (51b, 52b, 53b, 54b) is provided in the downstream first piping (61b, 63b).

According to the invention described in claim 1, the connection part between the first piping and the second piping has the long adjustment hole, which extends so as to allow adjustment of the relative angle between the first piping and the second piping. Hence, by rotating the connection part along the long hole shape of the adjustment hole, the relative angle (angle at which the second piping is attached to the first piping) can be adjusted with the second piping having substantially the same looseness. For this reason, a common second piping can be set, even when the height of the fuel injection device is set for each model. Accordingly, versatility of the second piping can be improved. Additionally, since versatility of the second piping is improved, cost can be reduced by mass production.

According to the invention described in claim 2, the adjustment hole includes the first adjustment hole formed in the first connection part, and the second adjustment hole formed in the second connection part. Since the first adjustment hole and the second adjustment hole are provided so as to sandwich the flow path forming portion, the second piping can be attached more stably to the first piping, as compared to a case where only a single adjustment hole is provided. Additionally, fine adjustment of the relative angle is facilitated.

According to the invention described in claim 3, the adjustment hole is formed into an arc shape, along the outer periphery of the first piping in side view. Since the relative angle can be adjusted with the first piping and the second piping joined temporarily, it is easier to attach the second piping to the first piping and work time can be reduced, as compared to a case where multiple round holes are arranged at predetermined intervals, along the outer periphery of the first piping in side view. Additionally, fine adjustment of the relative angle is facilitated.

According to the invention described in claim 4, the spacer is provided between the first piping and the supporting member. Hence, the height of the first piping can be adjusted by adjusting the height of the spacer. Therefore, a common first piping can be set, even when the capacity of the fuel injection device is varied. Accordingly, versatility of the first piping can be improved. Additionally, since versatility of the first piping is improved, cost can be reduced by mass production.

According to the invention described in claim 5, the adjustment hole is formed in both of the upstream connection part and the downstream connection part. Hence, the second piping can be used by inverting the upstream and downstream sides thereof. Accordingly, versatility of the second piping can be improved. Additionally, since versatility of the second piping is improved, cost can be reduced by mass production.

According to the invention described in claim 6, the upstream injector is provided in the upstream first piping, while the downstream injector is provided in the downstream first piping. Hence, a common first piping can be used even when the upstream injector and the downstream injector are varied, and versatility of the second piping can be improved. Therefore, cost can be reduced by mass production.

### BRIEF DESCRIPTION OF THE DRAWINGS

FIG. 1 is a left side view of a motorcycle of an embodiment of the present invention.

FIG. 2 is a left side view in which a main part of the aforementioned motorcycle is enlarged.

FIG. 3 is a top view of an air cleaner box of the aforementioned motorcycle.

FIG. 4 is a perspective view of a piping connection structure of the aforementioned motorcycle, as seen from the rear upper right direction.

FIG. 5 is a top view of the aforementioned piping connection structure.

FIG. 6 is a front view of the aforementioned piping connection structure.

FIG. 7 is a left side view of the aforementioned piping connection structure.

FIG. 8 is a right side view of the aforementioned piping connection structure.

FIG. 9 is a left side view in which a main part of the aforementioned piping connection structure is enlarged.

FIG. 10 is a perspective view of a supporting structure of a gyro sensor of the aforementioned motorcycle, as seen from the rear upper right direction.

FIG. 11 is a right side view of the aforementioned supporting structure of the gyro sensor, including an XI-XI section of FIG. 5.

FIG. 12 is a top view of a bracket in which the aforementioned gyro sensor is arranged.

### DESCRIPTION OF EMBODIMENTS

Hereinafter, an embodiment of the present invention will be described with reference to the drawings. Note that in the following description, directions such as front and rear, left and right are the same as directions of a vehicle described below, if not stated otherwise. Also, an arrow FR indicating the front of the vehicle, an arrow LH indicating the left of the vehicle, an arrow UP indicating the upper direction of the vehicle, and a vehicle left-right centerline CL are shown in appropriate parts in the drawings used in the following description.

### <Entire Vehicle>

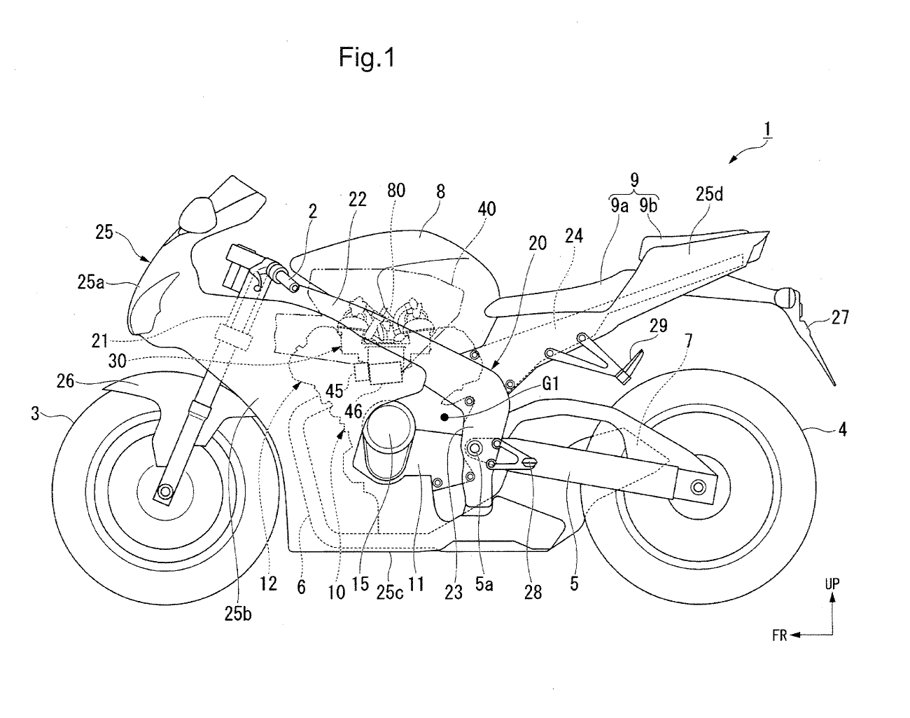

FIG. 1 shows a motorcycle 1 as an example of a straddle type vehicle. Referring to FIG. 1, the motorcycle 1 includes a bar handle 2, a front wheel 3 steered by the bar handle 2, and a rear wheel 4 driven by a power unit 10 including a V4 engine. The motorcycle is sometimes referred to simply as “vehicle” below.

Steering system parts including the bar handle 2 and the front wheel 3 are steerably and pivotally supported, to a head pipe 21 at the front end of a body frame 20. The power unit 10 is arranged in a longitudinal center part of the body frame 20. Paired left and right swing arms 5 are pivotally supported to a rear part of the power unit 10, so as to be vertically swingable around a pivot shaft 5a. An unillustrated rear suspension is interposed between front parts of the left and right swing arms 5 and a rear part of the body frame 20.

For example, the body frame 20 is formed by joining multiple kinds of steel materials into one body, by welding or other methods. The body frame 20 includes the head pipe 21, paired left and right main frames 22 extending in the rear lower direction from the head pipe 21, paired left and right pivot plates 23 connected to rear end parts of the paired left and right main frames 22 and extending downward, and paired left and right seat frames 24 connected to upper parts of the paired left and right pivot plates 23 and extending in the rear upper direction.

The power unit 10 is attached to the paired left and right pivot plates 23 and an unillustrated engine hanger. The power unit 10 includes a crankcase 11, a cylinder portion 12 arranged in an upper part of the crankcase 11 and formed into a V shape in side view, a generator cover 15 attached to a left side face of the crankcase 11, and an unillustrated clutch cover attached to a right side face of the crankcase 11.

A throttle body 30, which is connected to the cylinder portion 12 and configured to adjust the intake air amount, is provided above the power unit 10. An air cleaner box 40 for cleaning intake air of the throttle body 30 is provided, between the paired left and right main frames 22 in the vehicle width direction. A gyro sensor 80 is arranged inside the air cleaner box 40.

An exhaust pipe 6 is connected to the cylinder portion 12. The exhaust pipe 6 extends below the power unit 10, is arranged on the right side of the rear wheel 4, and is connected to a muffler 7 extending obliquely upward in the rear direction. A fuel tank 8 is arranged above the cylinder portion 12 and between the paired left and right main frames 22. A seat 9 is arranged behind the fuel tank 8 and on the paired left and right seat frames 24. The seat 9 includes a front seat 9a for the rider, and a rear seat 9b for the passenger.

A body cover 25 covers the body frame 20. The body cover 25 includes a front cowl 25a covering a front part of the body frame 20, a front side cowl 25b covering sides of a front part of the body frame 20, an under cowl 25c covering a lower part of the body frame 20, and a rear cowl 25d covering a rear part of the body frame 20.

A battery 45 and a power delivery unit (PDU) 46, which are rectangular in side view, are provided on the inner side in the vehicle width direction of the front side cowl 25b. The battery 45 and the power delivery unit 46 are attached to a left end part of the left main frame 22, through an unillustrated bracket. The battery 45 and the power delivery unit 46 are arranged adjacent to each other at the front and rear. Therefore, since the power delivery unit 46 is arranged closer to the battery 45, generation of unwanted resistance can be suppressed, and the current can be split effectively by the power delivery unit 46, as compared to a case where the battery 45 and the power delivery unit 46 are arranged away from each other. The current split by the power delivery unit 46 is supplied to the electric parts in appropriate current values.

Note that in FIG. 1, reference numeral 26 indicates a front fender, reference numeral 27 indicates a rear fender, reference numeral 28 indicates a main step on which the rider places his/her foot, reference numeral 29 indicates a pillion step on which the passenger places his/her foot, and reference numeral G1 indicates the position of the center of gravity of the vehicle 1.

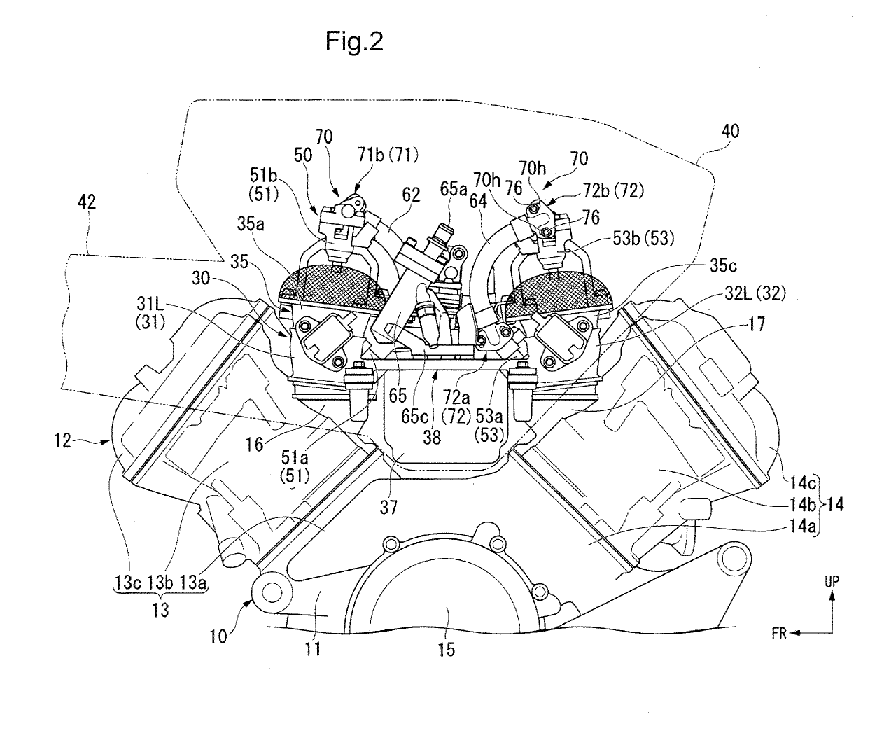

Also referring to FIG. 2, the cylinder portion 12 includes a front cylinder 13 and a rear cylinder 14, which are arranged at the front and rear with a gap in between. The front cylinder 13 protrudes toward the front upper direction from an upper part of the crankcase 11, while the rear cylinder 14 protrudes toward the rear upper direction from an upper part of the crankcase 11.

The front cylinder 13 includes a front cylinder block 13a formed integrally with a front upper part of the crankcase 11, a front cylinder head 13b attached to an upper end part of the front cylinder block 13a, and a front cylinder head cover 13c attached to an upper end part of the front cylinder head 13b.

The rear cylinder 14 includes a rear cylinder block 14a formed integrally with a rear upper part of the crankcase 11, a rear cylinder head 14b attached to an upper end part of the rear cylinder block 14a, and a rear cylinder head cover 14c attached to an upper end part of the rear cylinder head 14b.

A front intake port 16 is formed in a rear face of the front cylinder head 13b, while a rear intake port 17 is formed in a front face of the rear cylinder head 14b.

The air cleaner box 40 is arranged between the rear face of the front cylinder head 13b and the front face of the rear cylinder head 14b, so as to surround the throttle body 30 and other parts.

### <Air Cleaner Box>

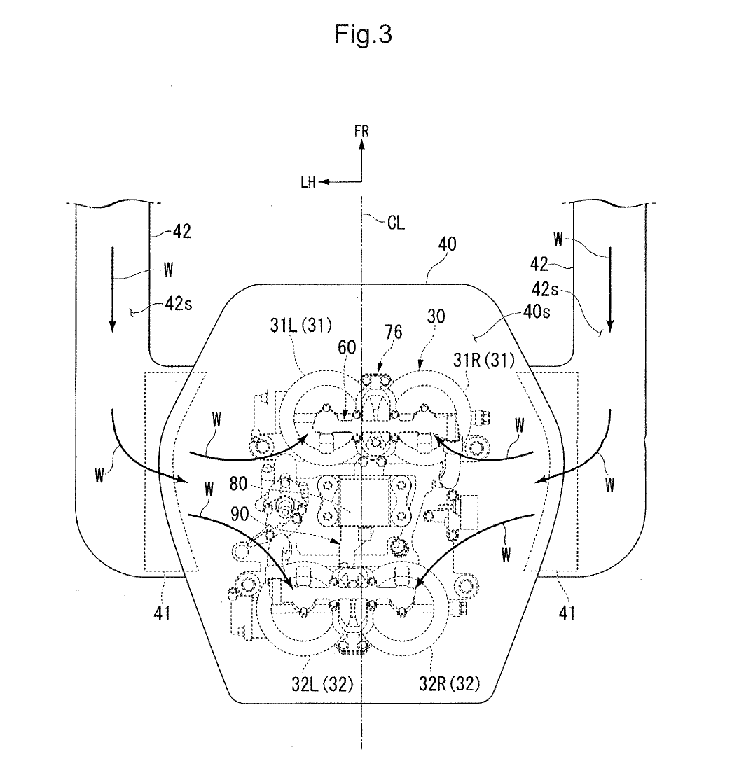

Also referring to FIG. 3, the air cleaner box 40 is formed into a hexagonal box shape having rounded corners in top view. Intake ducts 42 are connected to left and right sides of the air cleaner box 40. The left and right intake ducts 42 extend longitudinally along the vehicle left-right centerline CL in top view, curve inward in the vehicle width direction on the rear end sides, and reach the left and right sides of the air cleaner box 40.

Air cleaner elements 41 are provided inside inner end parts in the vehicle width direction of the left and right intake ducts 42, on left and right side faces of the air cleaner box 40 (connection parts between the air cleaner box 40 and the left and right intake ducts 42). The left and right air cleaner elements 41 separate dirty sides 42s inside the left and right intake ducts 42 and a clean side 40s inside the air cleaner box 40. The dirty side 42s is positioned on the upstream side of the air cleaner element 41, and the clean side 40s is positioned on the downstream side of the air cleaner element 41. The gyro sensor 80 is arranged on the clean side 40s.

Outside air introduced into the dirty sides 42s inside the left and right intake ducts 42 pass through the air cleaner elements 41 from outer to inner sides in the vehicle width direction thereof, is filtered and reaches the clean side 40s, and thereafter passes through the throttle body 30 and other parts, to be sucked into the cylinder portion 12. Note that arrows W in FIG. 3 indicate the flow of intake air.

### <Throttle Body>

Referring to FIG. 2, the throttle body 30 includes a front throttle body 31 connected to the front intake port 16, and a rear throttle body 32 connected to the rear intake port 17. The throttle body 30 adjusts the intake air amount by the front and rear throttle bodies 31, 32.

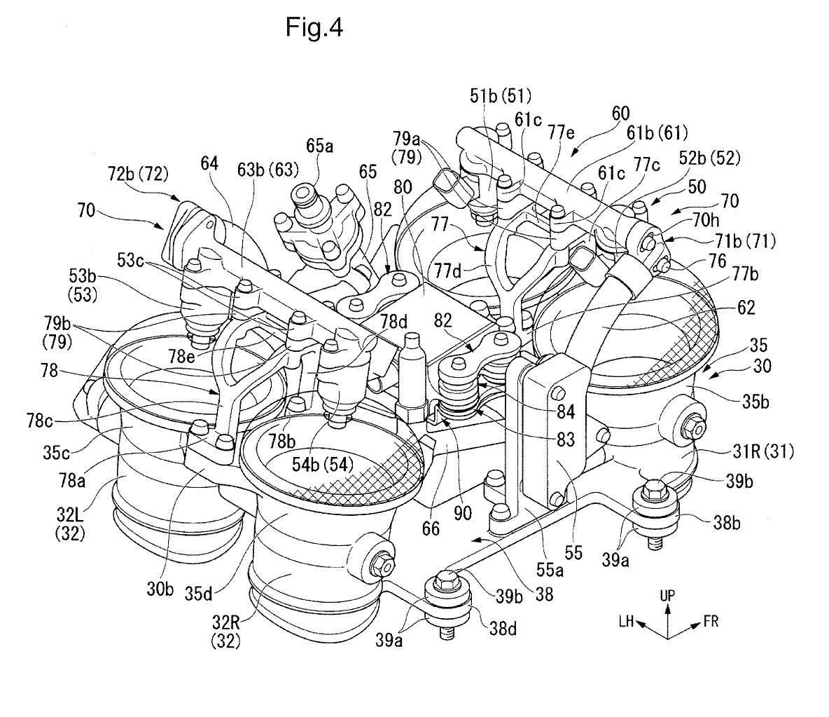

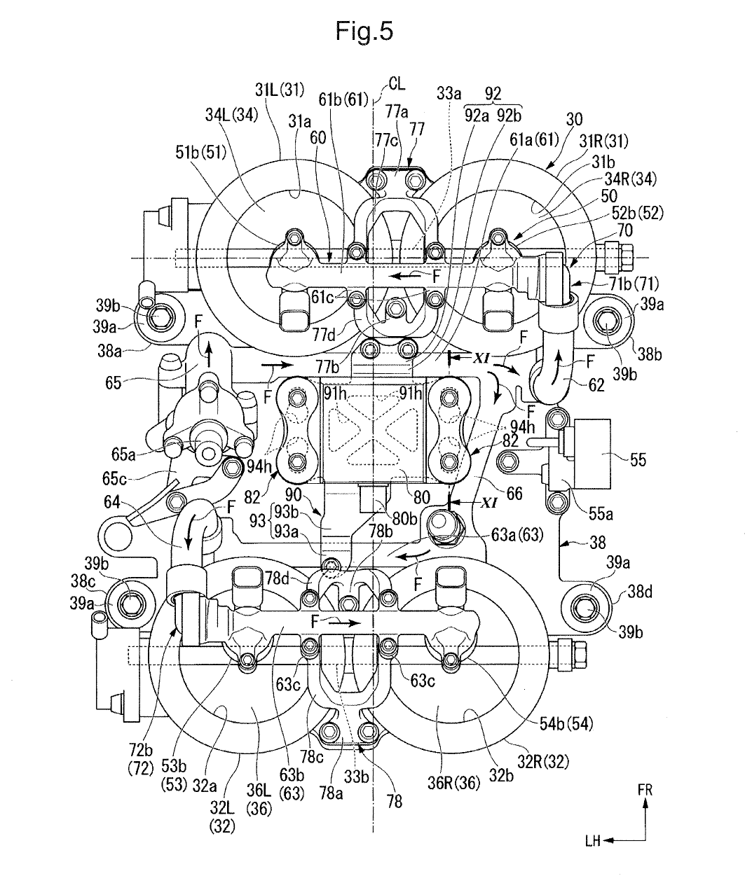

Also referring to FIGS. 4 and 5, the front throttle body 31 includes a left front throttle body 31L connected to a cylinder on the left front side of the engine, and a right front throttle body 31R connected to a cylinder on the right front side of the engine. A front valve shaft 33a extending along the vehicle width direction is rotatably supported, to the left front throttle body 31L and the right front throttle body 31R. A front throttle valve 34 is attached to the front valve shaft 33a. The front throttle valve 34 includes a left front throttle valve 34L for opening and closing an intake passage 31a inside the left front throttle body 31L, and a right front throttle valve 34R for opening and closing an intake passage 31b inside the right front throttle body 31R.

The rear throttle body 32 includes a left rear throttle body 32L connected to a cylinder on the left rear side of the engine, and a right rear throttle body 32R connected to a cylinder on the right rear side of the engine. A rear valve shaft 33b extending along the vehicle width direction is rotatably supported, to the left rear throttle body 32L and the right rear throttle body 32R. A rear throttle valve 36 is attached to the rear valve shaft 33b. The rear throttle valve 36 includes a left rear throttle valve 36L for opening and closing an intake passage 32a inside the left rear throttle body 32L, and a right rear throttle valve 36R for opening and closing an intake passage 32b inside the right rear throttle body 32R.

The front and rear throttle valves 34, 36 are driven by a valve driving device 37 (see FIG. 2), through an unillustrated link.

### <Intake Part>

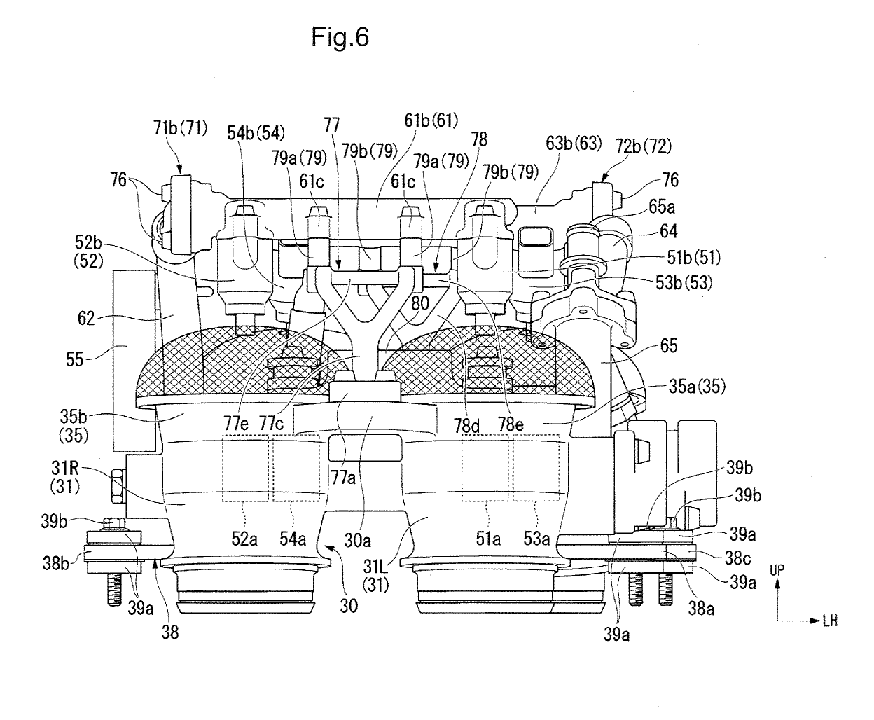

Also referring to FIG. 6, an intake part 35 is provided in an upper part of the throttle body 30. The intake part 35 includes a left front air funnel 35a in an upper part of the left front throttle body 31L, a right front air funnel 35b in an upper part of the right front throttle body 31R, a left rear air funnel 35c in an upper part of the left rear throttle body 32L, and a right rear air funnel 35d in an upper part of the right rear throttle body 32R. The gyro sensor 80 is arranged near the intake part 35. To be specific, the gyro sensor 80 is arranged in a space surrounded by the left front air funnel 35a, the right front air funnel 35b, the left rear air funnel 35c, and the right rear air funnel 35d.

A front connection portion 30a connecting the left front air funnel 35a and the right front air funnel 35b is formed, in an upper part of the front throttle body 31. The front connection portion 30a extends in the vehicle width direction so as to bridge the left front air funnel 35a and the right front air funnel 35b, and protrudes frontward so as to form a protrusion.

A rear connection portion 30b connecting the left rear air funnel 35c and the right rear air funnel 35d is formed, in an upper part of the rear throttle body 32. The rear connection portion 30b extends in the vehicle width direction so as to bridge the left rear air funnel 35c and the right rear air funnel 35d, and protrudes rearward so as to form a protrusion.

### <Connection Plate>

A connection plate 38 connecting the front and rear throttle bodies 31, 32 is provided, between the front and rear throttle bodies 31, 32 provided at the front and rear. The connection plate 38 is formed into a plate, which is thick in the vertical direction. Protrusions 38a to 38d, which protrude outward in the vehicle width direction, are formed in front and rear end parts of the connection plate 38. A through hole (not shown) opened in the vertical direction is formed in each of the protrusions 38a to 38d. The connection plate 38 is fixed to the paired left and right main frames 22 (see FIG. 1), through brackets (not shown). For example, the connection plate 38 is fastened and fixed, by inserting bolts 39b into the through holes while clamping upper and lower faces of each of the protrusions 38a to 38d with a collar 39a or other parts, and screwing the bolts 39b into nuts (none are shown) provided in the brackets. Note that the connection plate 38 may be fixed by welding, for example.

A fuel injection device 50 for injecting fuel to the intake passage inside the throttle body 30, auxiliary machinery 55 of electric parts and other parts, and piping 60 attached to the fuel injection device 50, are provided above the connection plate 38.

Note that the fuel injection device 50 may be provided so as to inject fuel to an intake passage outside the throttle body 30. That is, it suffices that the fuel injection device 50 be provided so as to inject fuel, to an intake passage including the throttle body 30.

### <Fuel Injection Device>

The fuel injection device 50 includes a left front injector 51 for injecting fuel to the intake passage 31a inside the left front throttle body 31L, a right front injector 52 for injecting fuel to the intake passage 31b inside the right front throttle body 31R, a left rear injector 53 for injecting fuel to the intake passage 32a inside the left rear throttle body 32L, and a right rear injector 54 for injecting fuel to the intake passage 32b inside the right rear throttle body 32R. The left front injector 51 and the right front injector 52 are arranged side by side in the vehicle width direction. The left rear injector 53 and the right rear injector 54 are arranged side by side in the vehicle width direction behind the left front injector 51 and the right front injector 52, with the gyro sensor 80 in between.

Here, the left front injector and the left rear injector correspond to “first injector” in the scope of claims, while the right front injector and the right rear injector correspond to “second injector” in the scope of claims. Note that the injectors 51, 53 and the injectors 52, 54 may each be arranged side by side in the direction that intersects with the vehicle width direction. That is, it suffices that each of the injectors 51, 52 and the injectors 53, 54 are arranged side by side in one direction.

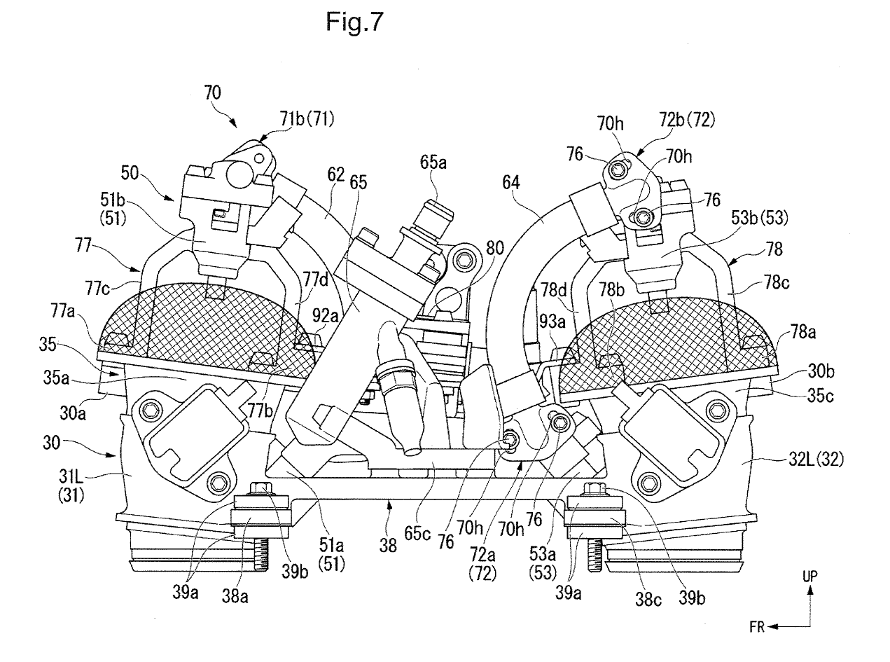

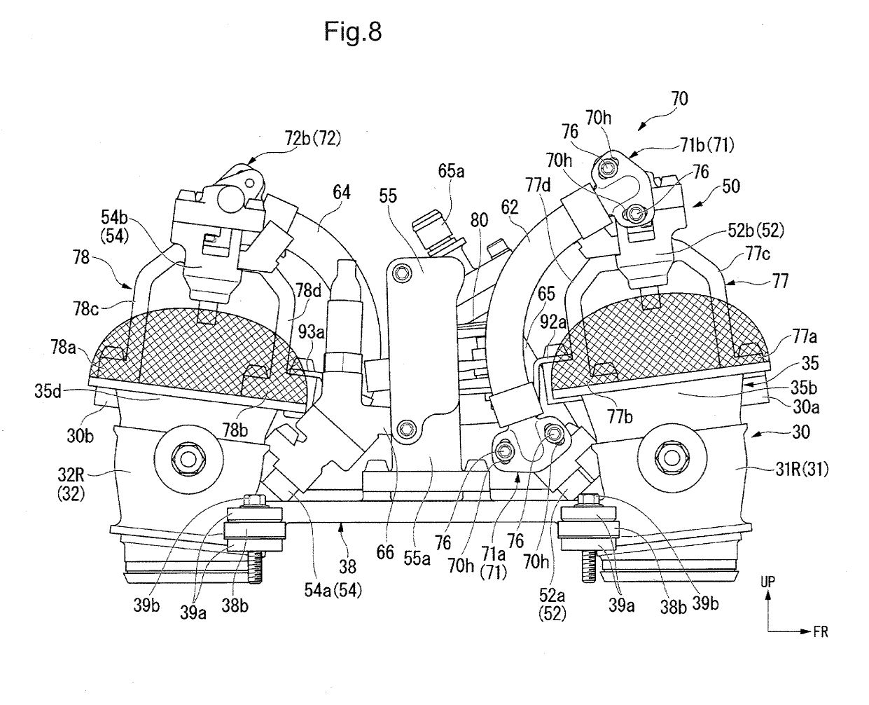

Also referring to FIGS. 7 and 8, the left front injector 51 includes: an upstream left front injector 51a, which is arranged on the lower side of the left front throttle body 31L (specifically, on a lower rear face of the left front throttle body 31L), and positioned on the upstream side of the flow of fuel; and a downstream left front injector 51b, which is arranged on the upper side of the left front throttle body 31L (specifically, a position facing the left front air funnel 35a), and positioned on the downstream side of the flow of fuel.

The right front injector 52 includes: an upstream right front injector 52a, which is arranged on the lower side of the right front throttle body 31R (specifically, on a lower rear face of the right front throttle body 31R), and positioned on the upstream side of the flow of fuel; and a downstream right front injector 52b, which is arranged on the upper side of the right front throttle body 31R (specifically, a position facing the right front air funnel 35b), and positioned on the downstream side of the flow of fuel.

The left rear injector 53 includes: an upstream left rear injector 53a, which is arranged on the lower side of the left rear throttle body 32L (specifically, on a lower front face of the left rear throttle body 32L), and positioned on the upstream side of the flow of fuel; and a downstream left rear injector 53b, which is arranged on the upper side of the left rear throttle body 32L (specifically, a position facing the left rear air funnel 35c), and positioned on the downstream side of the flow of fuel.

The right rear injector 54 includes: an upstream right rear injector 54a, which is arranged on the lower side of the right rear throttle body 32R (specifically, on a lower front face of the right rear throttle body 32R), and positioned on the upstream side of the flow of fuel; and a downstream right rear injector 54b, which is arranged on the upper side of the right rear throttle body 32R (specifically, a position facing the right rear air funnel 35d), and positioned on the downstream side of the flow of fuel.

Also referring to FIG. 6, the upstream left front injector 51a, the upstream right front injector 52a, the upstream left rear injector 53a, and the upstream right rear injector 54a are arranged in a center position in the vehicle width direction of the left front air funnel 35a, the right front air funnel 35b, the left rear air funnel 35c, and the right rear air funnel 35d, respectively.

Here, the upstream left front injector 51a, the upstream right front injector 52a, the upstream left rear injector 53a, and the upstream right rear injector 54a correspond to “upstream injector” in the scope of claims, while the downstream left front injector 51b, the downstream right front injector 52b, the downstream left rear injector 53b, and the downstream right rear injector 54b correspond to “downstream injector” in the scope of claims.

An upward rising bracket 55a is provided on an upper face in a right side part of the connection plate 38. The auxiliary machinery 55 is attached on a right side part of the bracket 55a.

### <Piping>

The piping 60 includes: front first piping 61 attached to the left front injector 51 and the right front injector 52; front second piping 62 provided separately from the front first piping 61, and having an end part connected to the front first piping 61 so as to intersect with the front first piping 61; rear first piping 63 attached to the left rear injector 53 and the right rear injector 54; and rear second piping 64 provided separately from the rear first piping 63, and having an end part connected to the rear first piping 63 so as to intersect with the rear first piping 63.

In the embodiment, the front first piping and the rear first piping are collectively referred to as “first piping,” and the front second piping and the rear second piping are collectively referred to as “second piping.”

The front first piping 61 includes an upstream front first piping 61a connected to the upstream side of the front second piping 62, and downstream front first piping 61b connected to the downstream side of the front second piping 62.

The rear first piping 63 includes upstream rear first piping 63a connected to the upstream side of the rear second piping 64, and downstream rear first piping 63b connected to the downstream side of the rear second piping 64.

Here, the upstream front first piping and the upstream rear first piping correspond to “upstream first piping” in the scope of claims, while the downstream front first piping and the downstream rear first piping correspond to “downstream first piping” in the scope of claims.

The upstream front first piping 61a is attached to the upstream left front injector 51a and the upstream right front injector 52a. The upstream front first piping 61a extends in the vehicle width direction so as to straddle the upstream left front injector 51a and the upstream right front injector 52a.

The downstream front first piping 61b is attached to the downstream left front injector 51b and the downstream right front injector 52b. The downstream front first piping 61b extends in the vehicle width direction so as to straddle the downstream left front injector 51b and the downstream right front injector 52b. The downstream front first piping 61b has multiple (e.g., a total of four including those at the front and rear in the embodiment) first protrusions 61c, which are spaced apart in the vehicle width direction for the length of a later-mentioned first connection shaft 77e, and protrude frontward and rearward so as to form protrusions.

In the embodiment, the upstream left front injector 51a and the upstream right front injector 52a are provided in the upstream front first piping 61a, while the downstream left front injector 51b and the downstream right front injector 52b are provided in the downstream front first piping 61b.

The upstream rear first piping 63a is attached to the upstream left rear injector 53a and the upstream right rear injector 54a. The upstream rear first piping 63a extends in the vehicle width direction so as to straddle the upstream left rear injector 53a and the upstream right rear injector 54a.

The downstream rear first piping 63b is attached to the downstream left rear injector 53b and the downstream right rear injector 54b. The downstream rear first piping 63b extends in the vehicle width direction so as to straddle the downstream left rear injector 53b and the downstream right rear injector 54b. The downstream rear first piping 63b has multiple (e.g., a total of four including those at the front and rear in the embodiment) second protrusions 63c, which are spaced apart in the vehicle width direction for the length of a later-mentioned second connection shaft 78e, and protrude frontward and rearward so as to form protrusions.

In the embodiment, the upstream left rear injector 53a and the upstream right rear injector 54a are provided in the upstream rear first piping 63a, while the downstream left rear injector 53b and the downstream right rear injector 54b are provided in the downstream rear first piping 63b.

A fuel filter 65 for removing foreign matter and others from fuel pumped from an unillustrated fuel pump is provided, at the upstream end of the upstream front first piping 61a. The fuel pressurized by the fuel pump is supplied from the fuel tank 8. In left side view of FIG. 7, the fuel filter 65 extends obliquely, such that it is positioned closer to the rear toward the upper side. A cylindrical nozzle 65a is provided at the upstream end of the fuel filter 65. Fuel supply piping (none are shown) leading to the fuel pump is connected to the nozzle 65a.

Connection piping 66 for connecting the downstream end of the upstream front first piping 61a and the upstream end of the upstream rear first piping 63a is provided, between the upstream front first piping 61a and the upstream rear first piping 63a. In top view of FIG. 5, the connection piping 66 extends obliquely, such that it is positioned closer to the left toward the rear side from the downstream end of the upstream front first piping 61a, and reaches the upstream end of the upstream rear first piping 63a.

### <Fuel Supply Path>

Hereinbelow, a supply path of fuel pumped from the fuel pump will be described. Note that in FIG. 5, arrows F indicate the flow of fuel.

The fuel pumped from the fuel pump is filtered through the fuel filter 65, and then flows into the upstream end of the upstream front first piping 61a. The fuel having flowed into the upstream end of the upstream front first piping 61a flows through the upstream front first piping 61a, and branches into the upstream left front injector 51a and the downstream side of the upstream front first piping 61a.

The fuel having branched to the upstream left front injector 51a is injected to the intake passage 31a, inside the left front throttle body 31L.

The fuel having branched into the downstream side of the upstream front first piping 61a, branches into the upstream right front injector 52a, the upstream end of the front second piping 62, and the upstream end of the connection piping 66.

The fuel having branched to the upstream right front injector 52a is injected to the intake passage 31b, inside the right front throttle body 31R.

The fuel having branched to the upstream end of the front second piping 62 flows through the front second piping 62, and flows into the upstream end of the downstream front first piping 61b. The fuel having flowed into the upstream end of the downstream front first piping 61b flows through the downstream front first piping 61b, and branches into the downstream right front injector 52b and the downstream side of the downstream front first piping 61b.

The fuel having branched to the downstream right front injector 52b is injected to the intake passage 31b, inside the right front throttle body 31R.

The fuel having branched to the downstream side of the downstream front first piping 61b flows through the downstream front first piping 61b, and flows into the downstream left front injector 51b. The fuel having flowed into the downstream left front injector 51b is injected to the intake passage 31a, inside the left front throttle body 31L.

The fuel having branched to the upstream side of the connection piping 66 flows through the connection piping 66, and branches into the upstream right rear injector 54a and the upstream end of the upstream rear first piping 63a.

The fuel having branched to the upstream right rear injector 54a is injected to the intake passage 32b, inside the right rear throttle body 32R.

The fuel having branched to the upstream end of the upstream rear first piping 63a flows through the upstream rear first piping 63a, and branches into the upstream left rear injector 53a and the upstream end of the rear second piping 64.

The fuel having branched to the upstream left rear injector 53a is injected to the intake passage 32a, inside the left rear throttle body 32L.

The fuel having branched to the upstream end of the rear second piping 64 flows through the rear second piping 64, and flows into the upstream end of the downstream rear first piping 63b. The fuel having flowed into the upstream end of the downstream rear first piping 63b flows through the downstream rear first piping 63b, and branches into the downstream left rear injector 53b and the downstream side of the downstream rear first piping 63b.

The fuel having branched to the downstream left rear injector 53b is injected to the intake passage 32a, inside the left rear throttle body 32L.

The fuel having branched to the downstream side of the downstream rear first piping 63b flows through the downstream rear first piping 63b, and flows into the downstream right rear injector 54b. The fuel having flowed into the downstream right rear injector 54b is injected to the intake passage 32b, inside the right rear throttle body 32R.

Thus, the fuel pumped from the fuel pump flows smoothly through the pipings 61 to 66. Then, the upstream and downstream left front injectors 51a, 51b inject fuel to the intake passage 31a inside the left front throttle body 31L, the upstream and downstream right front injectors 52a, 52b inject fuel to the intake passage 31b inside the right front throttle body 31R, the upstream and downstream left rear injectors 53a, 53b inject fuel to the intake passage 32a inside the left rear throttle body 32L, and the upstream and downstream right rear injectors 54a, 54b inject fuel to the intake passage 32b inside the right rear throttle body 32R. The gyro sensor 80 is arranged in a space surrounded by the fuel filter 65, the upstream front first piping 61a, the connection piping 66, and the upstream rear first piping 63a.

### <Connection Part>

Also referring to FIGS. 7 and 8, a front connection member 71 includes an upstream front connection member 71a connecting the downstream end of the upstream front first piping 61a and the upstream end of the front second piping 62, and a downstream front connection member 71b connecting the upstream end of the downstream front first piping 61b and the downstream end of the front second piping 62.

A rear connection member 72 includes an upstream rear connection member 72a connecting the downstream end of the upstream rear first piping 63a and the upstream end of the rear second piping 64, and a downstream rear connection member 72b connecting the upstream end of the downstream rear first piping 63b and the downstream end of the rear second piping 64.

Here, the upstream front connection member and the upstream rear connection member correspond to “upstream connection part” in the scope of claims, while the downstream front connection member and the downstream rear connection member correspond to “downstream connection part” in the scope of claims.

In the embodiment, connection parts of the pipings 61 to 64 provided between end parts of the pipings 61 to 64, are collectively referred to as “connection member.” A connection member 70 includes the front connection member 71 connecting the front first piping 61 and the front second piping 62, and the rear connection member 72 connecting the rear first piping 63 and the rear second piping 64.

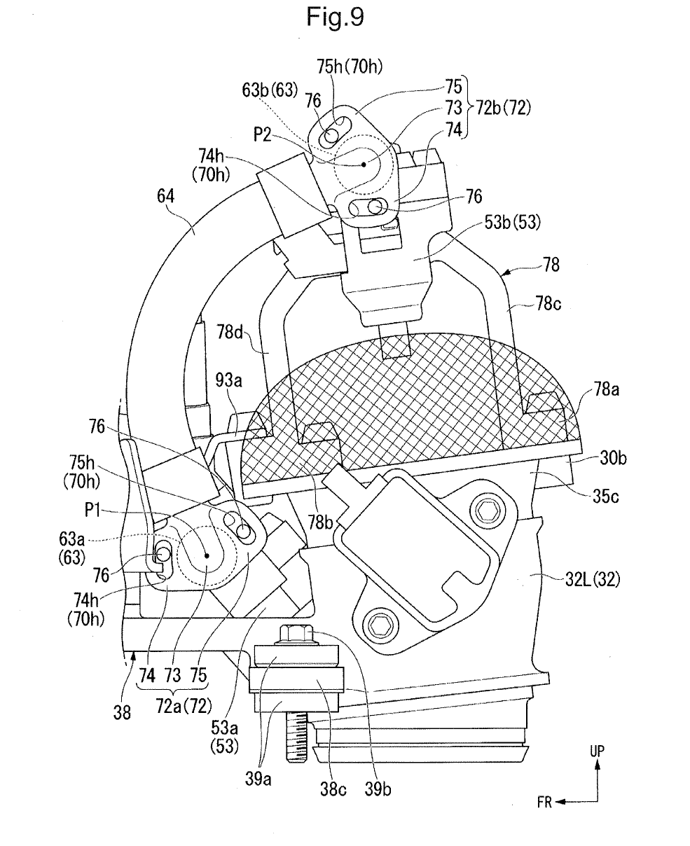

The front connection member 71 and the rear connection member 72 have long adjustment holes 70h, which each extend so as to allow adjustment of the relative angle between the front first piping 61 and the front second piping 62, and the relative angle between the rear first piping 63 and the rear second piping 64. Hereinafter, the adjustment hole 70h in the rear connection member 72 will be described with reference to FIG. 9. Since the adjustment hole 70h in the front connection member 71 is the same as the adjustment hole 70h in the rear connection member 72, detailed description thereof will be omitted. Note that in FIG. 9, reference numeral 76 indicates a bolt (bolt for fixing the connection members 71, 72) inserted into the adjustment hole 70h.

Referring to FIG. 9, in left side view, the rear connection member 72 (the upstream rear connection member 72a and the downstream rear connection member 72b) includes a flow path forming portion 73, a first connection portion 74 provided on one side of the flow path forming portion 73, and a second connection portion 75 provided on the other side of the flow path forming portion 73 opposite to the first connection portion 74.

The flow path forming portion 73 of the upstream rear connection member 72a forms a flow path, which guides fuel from the upstream rear first piping 63a to the rear second piping 64.

The flow path forming portion 73 of the downstream rear connection member 72b forms a flow path, which guides fuel from the rear second piping 64 to the downstream rear first piping 63b.

The adjustment hole 70h is formed in both of the upstream rear connection member 72a and the downstream rear connection member 72b.

The adjustment hole 70h of the upstream rear connection member 72a is formed into an arc shape, along the annular outer periphery of the upstream rear first piping 63a in left side view. In FIG. 9, point P1 is the center of the upstream rear first piping 63a. The adjustment hole 70h of the upstream rear connection member 72a, is capable of adjusting the relative angle between the upstream rear first piping 63a and the rear second piping 64 around point P1, when viewed from the vehicle width direction.

The adjustment hole 70h of the downstream rear connection member 72b is formed into an arc shape, along the annular outer periphery of the downstream rear first piping 63b in left side view. In FIG. 9, point P2 is the center of the downstream rear first piping 63b. The adjustment hole 70h of the downstream rear connection member 72b, is capable of adjusting the relative angle between the downstream rear first piping 63b and the rear second piping 64 around point P2, when viewed from the vehicle width direction.

The adjustment hole 70h includes a first adjustment hole 74h formed in the first connection portion 74, and a second adjustment hole 75h formed in the second connection portion 75.

When viewed from the vehicle width direction, the first adjustment hole 74h and the second adjustment hole 75h in the upstream rear connection member 72a, are shifted closer to the upper side (upstream end side of the rear second piping 64) than point P1, and are formed into arc shapes based on point P1.

When viewed from the vehicle width direction, the first adjustment hole 74h and the second adjustment hole 75h in the downstream rear connection member 72b are shifted closer to the front side (downstream end side of the rear second piping 64) than point P2, and are formed into arc shapes based on point P2.

### <Supporting Member>

Referring to FIGS. 4 to 6, supporting members 77, 78 for supporting the piping 60 are provided in the throttle body 30. The supporting members 77, 78 include the first supporting member 77 for supporting the downstream front first piping 61b, and the second supporting member 78 for supporting the downstream rear first piping 63b.

The first supporting member 77 includes: a front first base portion 77a fixed to the front connection portion 30a; a rear first base portion 77b fixed to the connection plate 38 behind the front first base portion 77a; a front first standing portion 77c standing up from the front first base portion 77a, and formed into a Y shape in front view of FIG. 6; a rear first standing portion 77d standing up from the rear first base portion 77b, and formed into a Y shape that overlaps with the front first standing portion 77c in front view of FIG. 6; and the first connection shaft 77e connecting left and right connection portions of the upper branch ends of the front first standing portion 77c and the upper branch ends of the rear first standing portion 77d, and formed into a bar extending in the vehicle width direction.

The second supporting member 78 includes: a rear second base portion 78a fixed to the rear connection portion 30b; a front second base portion 78b fixed to the connection plate 38 in front of the rear second base portion 78a; a rear second standing portion 78c standing up from the rear second base portion 78a, and formed into a Y shape in rear view; a front second standing portion 78d standing up from the front second base portion 78b, and formed into a Y shape that overlaps with the rear second standing portion 78c in rear view; and the second connection shaft 78e connecting left and right connection portions of the upper branch ends of the rear second standing portion 78c and the upper branch ends of the front second standing portion 78d, and formed into a bar extending in the vehicle width direction.

### <Spacer>

Referring to FIGS. 4 and 6, a spacer 79 is provided between the piping 60 and the supporting members 77, 78 (first supporting member 77, second supporting member 78). The spacer 79 includes a first spacer 79a arranged between the downstream front first piping 61b and the first supporting member 77, and a second spacer 79b arranged between the downstream rear first piping 63b and the second supporting member 78.

The first spacer 79a is formed such that collars, which are sandwiched between the front and rear first protrusions 61c of the downstream front first piping 61b, and upper end parts of the front and rear first standing portions 77c, 77d of the first supporting member 77, are combined as one body. The first spacer 79a is thick in the vertical direction, and has substantially the same length as the longitudinal length of the front and rear first protrusions 61c, in top view of FIG. 5. Note that the first spacer 79a may be a separate collar.

The second spacer 79b is formed such that collars, which are sandwiched between the front and rear second protrusions 63c of the downstream rear first piping 63b, and upper end parts of the front and rear second standing portions 78c, 78d of the second supporting member 78, are combined as one body. The second spacer 79b has a smaller thickness in the vertical direction than the first spacer 79a, and has substantially the same length as the longitudinal length of the front and rear second protrusions 63c, in top view of FIG. 5. Note that the second spacer 79b may be a separate collar.

### <Gyro Sensor>

Referring to FIG. 5, the gyro sensor 80 is positioned on the vehicle left-right centerline CL. To be specific, the gyro sensor 80 has a rectangular parallelepiped main body part, and is arranged such that the center of the main body part in the vehicle width direction overlaps with the vehicle left-right centerline CL in top view. This can reduce the influence of left and right tilting of the vehicle.

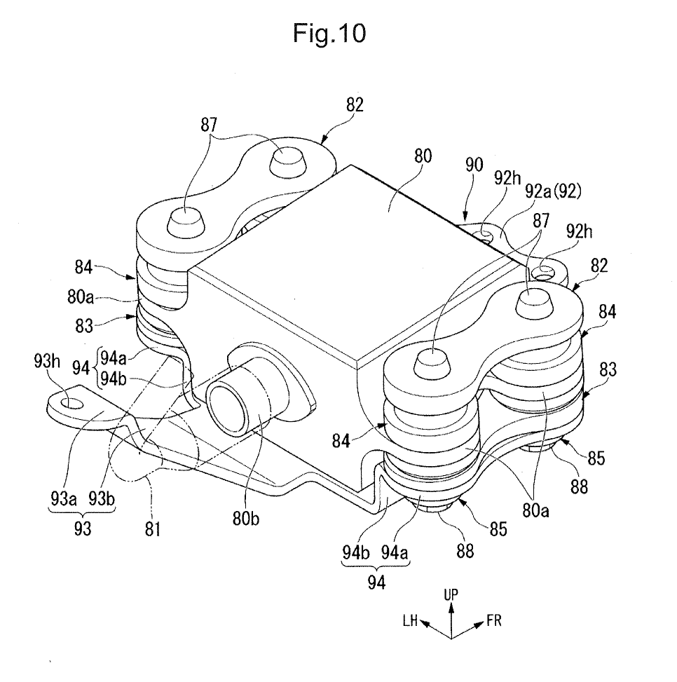

Also referring to FIG. 10, an attachment flange 80a for attaching the gyro sensor 80 is formed in both left and right end parts of the gyro sensor 80. The attachment flanges 80a protrude to the left and right sides from both left and right side faces of the gyro sensor 80. Two each of the attachment flanges 80a are arranged on the left and right, so as to correspond to attachment parts (a front and rear pair on both left and right side faces of the gyro sensor 80) of the gyro sensor 80.

A wiring connection portion 80b for connecting wiring 81 that leads to an unillustrated control unit is formed, in a rear end part of the gyro sensor 80.

The gyro sensor 80 is fastened and fixed to a bracket 90 with bolts 87 and nuts 88 through grommets 84 (elastic members), with the grommets 84 attached to the left and right attachment flanges 80a, an upper correction plate 82 arranged above the attachment flanges, and a lower correction plate 83 arranged below the attachment flanges.

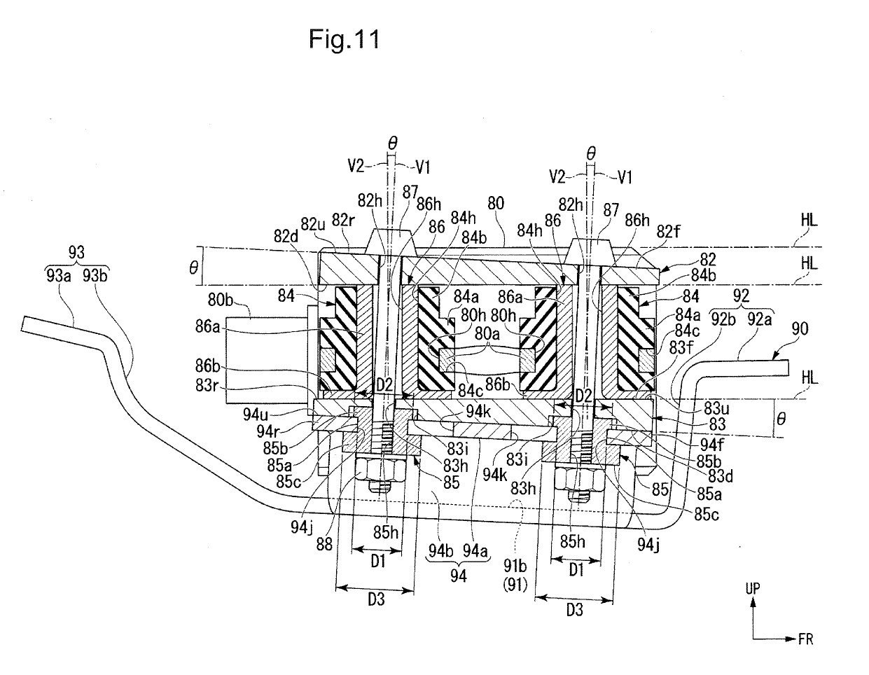

Also referring to FIG. 11, attachment holes 80h, which are opened in the vertical direction at positions corresponding to the attachment parts of the gyro sensor 80, are formed in the attachment flange 80a. The attachment hole 80h has a larger pore size than the outer diameter of a shaft part of the bolt 87.

### <Bracket>

Referring to FIGS. 4 and 5, the bracket 90 supported to the throttle body 30 is provided, between the first supporting member 77 and the second supporting member 78. The bracket 90 is arranged so as to bridge the front throttle body 31 and the rear throttle body 32. The bracket 90 is formed into a longitudinally-extending shape connecting the rear first base portion 77b of the first supporting member 77, and the front second base portion 78b of the second supporting member 78. The gyro sensor 80 is arranged in a longitudinal center part of the bracket 90.

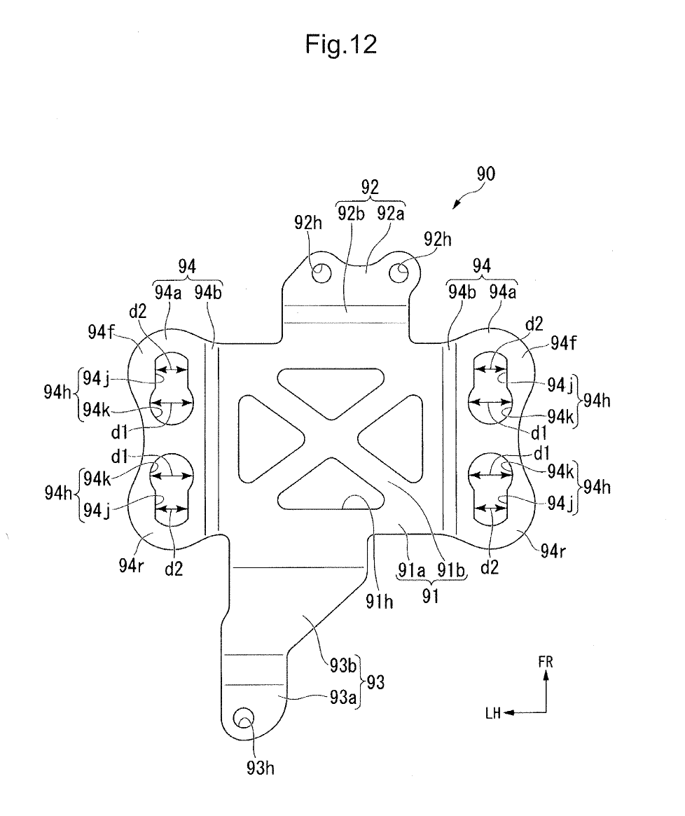

Also referring to FIGS. 11 and 12, the bracket 90 has a main body portion 91 facing a lower face of the gyro sensor 80, a front extension portion 92 provided on a front end part of the main body portion 91, a rear extension portion 93 provided on a rear end part of the main body portion 91, and left and right supporting portions 94 provided on left and right end parts of the main body portion 91.

The main body portion 91 has a rectangular frame-shaped frame portion 91a, and an X-shaped connection portion 91b in top view of FIG. 12. The main body portion 91 has an opening portion 91h, which is opened in the vertical direction and formed into a triangular shape having rounded corners, in top view of FIG. 12.

The front extension portion 92 includes a front connection portion 92a connected to the rear first base portion 77b of the first supporting member 77, and a front wall portion 92b bridging the rear end of the front connection portion 92a and the front end of the main body portion 91. In right side view of FIG. 11, the front wall portion 92b extends frontward from the front end of the main body portion 91, and then rises steeply toward the front upper direction to reach the rear end of the front connection portion 92a. The front connection portion 92a has paired left and right through holes 92h, which are opened in the thickness direction of the front connection portion 92a.

For example, the front connection portion 92a is fastened and fixed by inserting bolts into the through holes 92h, and screwing the bolts into nuts (not shown) provided in the rear first base portion 77b. Note that the front connection portion 92a may be fixed by welding, for example.

The rear extension portion 93 includes a rear connection portion 93a connected to the front second base portion 78b of the second supporting member 78, and a rear wall portion 93b bridging the front end of the rear connection portion 93a and the rear end of the main body portion 91. In right side view, the rear wall portion 93b extends rearward from the rear end of the main body portion 91, extends gradually toward the rear upper direction, and then rises steeply toward the rear upper direction to reach the front end of the rear connection portion 93a. The rear connection portion 93a has a through hole 93h, which is opened in the thickness direction of the rear connection portion 93a.

For example, the rear connection portion 93a is fastened and fixed by inserting a bolt into the through hole 93h, and screwing the bolt into a nut (not shown) provided in the front second base portion 78b. Note that the rear connection portion 93a may be fixed by welding, for example.

The left and right supporting portions 94 include: left and right collar supporting portions 94a formed into a plate that can support collars 85; and left and right wall portions 94b bridging inner ends in the vehicle width direction of the left and right collar supporting portions 94a, and outer ends in the vehicle width direction of the main body portion 91. The left and right wall portions 94b extend upward from left and right ends of the main body portion 91, and reach the inner ends in the vehicle width direction of the left and right collar supporting portions 94a.

The left and right collar supporting portions 94a have long holes 94h, which each includes: a large-diameter portion 94k opened in the thickness direction of the left and right collar supporting portions 94a, and having an inner diameter d1 larger than an outer diameter D2 of a later-mentioned upper flange portion 85b (flange portion); and a small-diameter portion 94j continuous with the large-diameter portion 94k, and having an inner diameter d2 larger than an outer diameter D1 of a later-mentioned tube portion 85a and smaller than the outer diameter D2. For example, the long hole 94h is a hook slot. This can prevent the collar 85 from falling off when the bolt 87 is detached.

Note that the inner diameter d1 of the large-diameter portion 94k may be the same as the outer diameter D2 of the upper flange portion 85b, and the inner diameter d2 of the small-diameter portion 94j may be the same as the outer diameter D1 of the tube portion 85a.

The long holes 94h are opened in positions where the small-diameter portions 94j are respectively aligned with the attachment holes 80h. The long holes 94h are arranged at the front and rear, such that the large-diameter portions 94k are positioned closer to the longitudinal center part of the left and right collar supporting portions 94a. This can make the left and right collar supporting portions 94a smaller than a case where the large-diameter portions 94k are positioned closer to front and rear end parts of the left and right collar supporting portions 94a. Hence, the left and right collar supporting portions 94a can be arranged favorably, in the space between the front throttle body 31 and the rear throttle body 32.

The left and right collar supporting portions 94a have a front supporting portion 94f in a position surrounding the small-diameter portion 94j, and a rear supporting portion 94r in a position behind the front supporting portion 94r. The front and rear supporting portions 94f, 94r have wide seating faces, on the outer side in the radial direction of the small-diameter portion 94j and on the outer side in the vehicle width direction, of longitudinal center parts of the left and right collar supporting portions 94a.

### <Grommet>

The grommet 84 is formed into a cylindrical shape having a through hole 84h, which is opened in the vertical direction. The grommet 84 has a first tube portion 84a, and a second tube portion 84b having a smaller outer diameter than the outer diameter of the first tube portion 84a. An annular groove 84c, which is recessed radially inward from the outer peripheral surface of the first tube portion 84a, is formed on an outer peripheral part of the first tube portion 84a. An edge part surrounding the attachment hole 80h of the attachment flange 80a fits into the groove 84c. The grommet 84 protrudes to upper and lower sides from the attachment flange 80a, with the groove 84c fitted into the edge part.

A flanged collar 86 is inserted into the through hole 84h of the grommet 84. The flanged collar 86 includes: a shaft portion 86a, which is formed into a cylindrical shape having a through hole 86h opened in the vertical direction; and a flange portion 86b, which is formed into an annular shape protruding radially outward from a lower end part of the shaft portion 86a. The vertical length of the shaft portion 86a is slightly larger than the vertical length of the grommet 84. The flange portion 86b abuts on a lower end face of the first tube portion 84a, with the flanged collar 86 inserted into the through hole 84h of the grommet 84.

### <Correction Plate>

The upper correction plate 82 is formed into a plate, which extends in the longitudinal direction and is tapered in cross-sectional view of FIG. 11. The upper correction plate 82 is a rigid member such as metal, and has a horizontal seating face 82d (lower face), and an inclined face 82u (upper face), which is inclined at an angle θ with respect to the seating face 82d. The upper correction plate 82 has through holes 82h opened in the vertical direction, in positions corresponding to the attachment holes 80h. The through hole 82h is formed perpendicular to the inclined face 82u, and has a pore size slightly larger than the outer diameter of the shaft part of the bolt 87. The upper correction plate 82 has a front seat portion 82f and a rear seat portion 82r thicker than the front seat portion 82f, in positions surrounding the through holes 82h. The front and rear seat portions 82f, 82r have wide seating faces, on the outer side in the vehicle width direction of a longitudinal center part of the upper correction plate 82.

The lower correction plate 83 is formed into a plate, which extends in the longitudinal direction, and is tapered in such a manner that the upper correction plate 82 is inverted in the longitudinal direction and the inclination direction is reversed in cross-sectional view of FIG. 11. The lower correction plate 83 is a rigid member such as metal, and has a horizontal seating face 83u (upper face), and an inclined face 83d (upper face), which is inclined at the angle θ with respect to the seating face 83u. The lower correction plate 83 has through holes 83h opened in the vertical direction, in positions corresponding to the attachment holes 80h. The through hole 83h is formed perpendicular to the inclined face 83d, and has a pore size slightly larger than the outer diameter of the shaft part of the bolt 87. The lower correction plate 83 has a front seat portion 83f and a rear seat portion 83r thinner than the front seat portion 83f, in positions surrounding the through holes 83h. The front and rear seat portions 83f, 83r have wide seating faces, on the outer side in the vehicle width direction of a longitudinal center part of the lower correction plate 83. Concave portions 83i depressed upward are formed in the inclined face 83d of the lower correction plate 83, in positions surrounding the through holes 83h.

Since the gyro sensor 80 is attached to a supporting face 94u through the upper and lower correction plates 82, 83, it is possible to correct the attachment angle of the gyro sensor 80 with respect to the supporting face 94u and maintain the horizontal state, even when the supporting face 94u is inclined for the angle θ with respect to a horizontal line HL.

Note that the inclination angle θ of the supporting face 94u is equivalent to an angle of change in longitudinal inclination of the vehicle body, which has changed due to adjustment in a front-wheel suspension device and a rear-wheel suspension device (none are shown), i.e., the difference between the inclination angle after adjustment, and the inclination angle in the normal state. In the embodiment, the vehicle body is inclined frontward for the angle θ.

### <Collar>

The collar 85 includes: a cylindrical tube portion 85a having a through hole 85h opened in the vertical direction; the annular upper flange portion 85b protruding radially outward from an upper end part of the tube portion 85a, and having the outer diameter D2 larger than the outer diameter D1 of the tube portion 85a; and a lower flange portion 85c protruding radially outward from a lower end part of the tube portion 85a, and having an outer diameter D3 larger than the outer diameter D2 of the upper flange portion 85b.

Of the collars 85, the upper flange portions 85b and the tube portions 85a are inserted into the large-diameter portions 94k of the left and right collar supporting portions 94a, and are slid toward the small-diameter portions 94j. Thus, the collars 85 are supported to the front and rear supporting portions 94f, 94r of the left and right collar supporting portions 94a, with the tube portions 85a inserted into the small-diameter portions 94j of the left and right collar supporting portions 94a, and the upper and lower flange portions 85b, 85c arranged such that they sandwich the small-diameter portions 94j from upper and lower sides. Note that the vertical gap between the upper flange portion 85b and the lower flange portion 85c is substantially the same size as the thickness of the left and right collar supporting portions 94a.

### <Attachment of Gyro Sensor>

Hereinafter, a description will be given of an example of how to attach the gyro sensor 80.

First, the inclined face 83d of the lower correction plate 83 is placed on the supporting faces 94u (upper face) of the left and right collar supporting portions 94a, such that the upper flange portions 85b are accommodated inside the concave portions 83i, with the collars 85 supported to the front and rear supporting portions 94f, 94r of the left and right collar supporting portions 94a, and the through holes 83h in the lower correction plate 83 are aligned with the through holes 85h in the collars 85. Note that the depth of the concave portion 83i is substantially the same as the thickness of the upper flange portion 85b.

Of the lower correction plate 83, the inclined face 83d is inclined upward toward the rear for the angle θ, with respect to the seating face 83u, and therefore the seating face 83u is parallel to the horizontal line HL. At this time, since the through holes 83h in the lower correction plate 83 are formed perpendicular to the inclined face 83d, the axes of the through holes 83h overlap with axes V1 of the through holes 85h in the collars 85, and the through holes 83h become continuous with the through holes 85h on the same axis. Note that the axis V1 is perpendicular to the supporting face 94u, and therefore is inclined for the angle θ with respect to a vertical line V2.

Next, the lower ends of the flange portions 86b of the flanged collars 86 are placed on the seating face 83u of the lower correction plate 83, with the grommets 84 and the flanged collars 86 attached to the attachment flanges 80a of the gyro sensor 80, and the through holes 86h in the flanged collars 86 are aligned with the through holes 83h in the lower correction plate 83. At this time, since the seating face 83u of the lower correction plate 83 is parallel to the horizontal line HL, the flange portions 86b and the attachment flanges 80a are also parallel to the horizontal line HL. Note that the axes of the grommets 84 and flanged collars 86 coincide with the vertical line V2.

Next, the seating face 82d of the upper correction plate 82 is placed on the upper end of the shaft portions 86a of the flanged collars 86, and the through holes 82h in the upper correction plate 82 are aligned with the through holes 86h in the flanged collars 86. At this time, since the through holes 82h in the upper correction plate 82 are formed perpendicular to the inclined face 82u, the axes of the through holes 82h overlap with the axes V1.

In this state, the shaft parts of the bolts 87 are inserted into the through holes 82h in the upper correction plate 82, the through holes 86h in the flanged collars 86, the through holes 83h in the lower correction plates 83, and the through holes 85h in the collars 85, and then screw parts protruding downward from the lower flange portions 85c of the collars 85 are fastened and fixed to the nuts 88. Thus, the gyro sensor 80 is supported to the bracket 90. Note that the screw part of the bolt 87 may be fastened and fixed to the collar 85, by providing an internal thread in the collar 85.

As has been described, the above embodiment is a piping connection structure of the vehicle 1 including: the throttle body 30 connected to the power unit 10 of the vehicle 1 to adjust the intake air amount; the fuel injection device 50 for injecting fuel to the intake passage including the throttle body 30; the first pipings 61, 63 attached to the fuel injection device 50; and the second pipings 62, 64 provided separately from the first pipings 61, 63, and having end parts connected to the first pipings 61, 63 so as to intersect with the first pipings 61, 63, in which the connection member 70 between the first pipings 61, 63 and the second pipings 62, 64 has long adjustment holes 70h, which extend so as to allow adjustment of the relative angles between the first pipings 61, 63 and the second pipings 62, 64.

According to this configuration, the connection member 70 between the first pipings 61, 63 and the second pipings 62, 64 has the long adjustment holes 70h, which extend so as to allow adjustment of the relative angles between the first pipings 61, 63 and the second pipings 62, 64. Hence, by rotating the connection member 70 along the long hole shape of the adjustment holes 70h, the relative angles (angles at which the second pipings 62, 64 are attached to the first pipings 61, 63) can be adjusted with the second pipings 62, 64 having substantially the same looseness. For this reason, common second pipings 62, 64 can be set, even when the height of the fuel injection device 50 is set for each model. Accordingly, versatility of the second pipings 62, 64 can be improved. Additionally, since versatility of the second pipings 62, 64 is improved, cost can be reduced by mass production.

Also, in the above embodiment, the adjustment hole 70h includes the first adjustment hole 74h formed in the first connection portion 74, and the second adjustment hole 75h formed in the second connection portion 75. Since the first adjustment hole 74h and the second adjustment hole 75h are provided so as to sandwich the flow path forming portion 73, the second pipings 62, 64 can be attached more stably to the first pipings 61, 63, as compared to a case where only a single adjustment hole is provided. Additionally, fine adjustment of the relative angle is facilitated.

Also, in the above embodiment, the adjustment holes 70h are formed into arc shapes, along the outer periphery of the first pipings 61, 63 when viewed from the vehicle width direction. Since the relative angle can be adjusted with the first pipings 61, 63 and the second pipings 62, 64 joined temporarily, it is easier to attach the second pipings 62, 64 to the first pipings 61, 63 and work time can be reduced, as compared to a case where multiple round holes are arranged at predetermined intervals, along the outer periphery of the first piping 61, 63 when viewed from the vehicle width direction. Additionally, fine adjustment of the relative angle is facilitated.

Also, in the above embodiment, the spacer 79 is provided between the first pipings 61, 63 and the supporting members 77, 78. Hence, the height of the first pipings 61, 63 can be adjusted by adjusting the height of the spacer 79. Therefore, common first pipings 61, 63 can be set, even when the capacity of the fuel injection device 50 is varied. Accordingly, versatility of the first pipings 61, 63 can be improved. Additionally, since versatility of the first pipings 61, 63 is improved, cost can be reduced by mass production.

Also, in the above embodiment, the adjustment holes 70h are formed in both of the upstream connection members 71a, 72a, and the downstream connection members 71b, 72b. Hence, the second pipings 62, 64 can be used by inverting the upstream and downstream sides thereof. Accordingly, versatility of the second pipings 62, 64 can be improved. Additionally, since versatility of the second pipings 62, 64 is improved, cost can be reduced by mass production.

Also, in the above embodiment, the upstream injectors 51a to 54a are provided in the upstream first pipings 61, 63a, while the downstream injectors 51b to 54b are provided in the downstream first pipings 61b, 63b. Hence, common first pipings 61a, 61b, 63a, 63b can be used even when the upstream injectors 51a to 54a and the downstream injectors 51b to 54b are varied, and versatility of the second pipings 62, 64 can be improved. Therefore, cost can be reduced by mass production.

Note that the present invention is not limited to the above embodiment, and, for example, the straddle type vehicle includes general vehicles that a rider rides by straddling the vehicle body, and includes not only a motorcycle (including a motorized bicycle and a scooter type vehicle), but also three-wheeled vehicles (including vehicles two-wheeled at the front and one-wheeled at the rear, in addition to those one-wheeled at the front and two-wheeled at the rear).

The configuration of the above embodiment is one example of the present invention, and various changes, such as replacing a component of the embodiment with a known component, can be made without departing from the gist of the invention.

1. A piping connection structure of a vehicle comprising:
a throttle body connected to a power unit of the vehicle to adjust an intake air amount;
a fuel injection device for injecting fuel to an intake passage including said throttle body;
first piping attached to said fuel injection device; and
second piping provided separately from said first piping, and having an end part connected to said first piping so as to intersect with said first piping, wherein
a connection part between said first piping and said second piping has a long adjustment hole, which extends so as to allow adjustment of a relative angle between said first piping and said second piping.

2. The piping connection structure according to claim 1, wherein:
said connection part includes a flow path forming portion forming a flow path that guides fuel from said second piping to said first piping, a first connection part provided on one side of said flow path forming portion, and a second connection part provided on the other side of said flow path forming portion opposite to said first connection part; and
said adjustment hole includes a first adjustment hole formed in said first connection part, and a second adjustment hole formed in said second connection part.

3. The piping connection structure according to claim 1, wherein:
said fuel injection device includes a first injector and a second injector;
said first injector and said second injector are arranged side by side in the vehicle width direction;
said first piping extends in the vehicle width direction, so as to straddle said first injector and said second injector; and
said adjustment hole is formed into an arc shape, along the outer periphery of said first piping in side view.

4. The piping connection structure according to claim 1, wherein:
a supporting member supporting said first piping is provided in said throttle body; and
a spacer is provided between said first piping and said supporting member.

5. The piping connection structure according to claim 1, wherein:
said first piping includes upstream first piping connected to the upstream side of said second piping, and downstream first piping connected to the downstream side of said second piping;
said connection part includes an upstream connection part connecting said upstream first piping and the upstream side of said second piping, and a downstream connection part connecting said downstream first piping and the downstream side of said second piping; and
said adjustment hole is formed in both of said upstream connection part and said downstream connection part.

6. The piping connection structure according to claim 5, wherein:
said fuel injection device includes a first injector and a second injector;
said first injector and said second injector each includes an upstream injector and a downstream injector;
said upstream injector is provided in said upstream first piping; and
said downstream injector is provided in said downstream first piping.
